(19) United States
(12) Patent Application Publication
(10) Pub. No.: US 2005/0108528 A1
(43) Pub. Date: May 19, 2005

(54) Computer network and method for transmitting and authenticating data in the computer network

(75) Inventors: Paul J. Wanish, Poughkeepsie, NY (US); Frank J. DeGilio, Poughkeepsie, NY (US)

Correspondence Address: Philmore H. Colburn II;Cantor Colburn LLP, 55 Griffin Road South, Bloomfield, CT, 06002, US

(73) Assignee: INTERNATIONAL BUSINESS MACHINES CORPORATION, ARMONK, NY (US)

(21) Appl. No.: 10/716,996

(22) Filed: Nov. 19, 2003

(51) Int. Cl. H04L 9/00

(52) U.S. Cl. 713/168

(57) ABSTRACT

A computer network and a method for transmitting data through the computer network is provided. The computer network includes a first computer and a second computer both having a message sequence number stored therein. The method includes transmitting a message containing a message identifier, and encrypted message sequence number, and encrypted data from the first computer to the second computer. The method further includes decrypting in the encrypted message sequence number to authenticate the identity of the sending party who transmitted the message. Finally, the method includes the second computer initiating transmission of the message sequence number and the encrypted data to a third computer when the identity of the sending party is authenticated.

### FIELD OF INVENTION

The invention relates to a computer network and a method for transmitting and authenticating data in the computer network.

### BACKGROUND OF INVENTION

Known computer networks have transmitted encrypted messages between computers to protect the integrity of the data. However, in known systems a message sender's computer generally encrypts (i) a public key identifying the sender and (ii) data. Generally, when a first computer transmits the encrypted message to a second authentication computer server used to authenticate the identity of the sender, the entire message (public key and data) is decrypted by the second computer. In other words, the second computer decrypts the public key and the data. Thus, when the data in the message is relatively large, the second computer must utilize a substantial amount of processing capacity to decrypt the data. Thereafter, the second computer may re-encrypt the message after authentication of the sender is performed, and then transmit the encrypted message to a third computer. The third computer may comprise a computer containing software applications that will utilize the data in the message.

The inventors herein have recognized that known systems during the transmission and authentication of a message (i) encrypts data in the transmitted message at least two times and (ii) decrypt the data in a message at least two times. The duplicative encryption and decryption of relatively large amounts of data in the messages utilizes a large amount of computer processing capacity and time. Thus, when a relatively large number of messages are being sent to an authentication computer server, the server may not have sufficient processing capacity to efficiently and quickly encrypt and decrypt the messages. Thus, the inventors herein have recognized that there is a need for a system that allows the transmission and authentication of a message while reducing the amount of times the data associated with the message is encrypted and decrypted.

### SUMMARY OF INVENTION

The foregoing problems and disadvantages are overcome by a computer network and a method for transmitting data in the computer network as described herein.

A method for transmitting data through a computer network in accordance with exemplary embodiments is provided. The computer network includes a first computer and a second computer both having a message sequence number stored therein. The method includes transmitting a message containing a message identifier, an encrypted message sequence number, and encrypted data from the first computer to the second computer. The method further includes decrypting the encrypted message sequence number to authenticate the identity of the sending party who transmitted the message. Finally, the method includes the second computer initiating transmission of the message sequence number and the encrypted data to a third computer when the identity of the sending party is authenticated.

A computer network in accordance with exemplary embodiments is provided. The computer network includes a first computer operably communicating with a second computer. The first computer and the second computer both have a predetermined message sequence number stored therein. A third computer operably communicates with the second computer. The first computer is configured to transmit a message containing a message identifier, an encrypted message sequence number, and encrypted data to the second computer. The second computer is configured to decrypt the encrypted message sequence number to authenticate the identity of the sending party who transmitted the message. The second computer is further configured to transmit the sequence number and the encrypted data to the third computer after the identity of the sending party is authenticated by the second computer.

Other systems, methods and/or computer program products according to the embodiments will be or become apparent to one with skill in the art upon review of the following drawings and detailed description. It is intended that at all such additional systems, methods, and/or computer program products be within the scope of the present invention, and be protected by the accompanying claims.

### BRIEF DESCRIPTION DRAWINGS

FIG. 1 is a block diagram of computer network having a client computer, and authentication computer server, and an application computer server.

FIG. 2 is an exemplary access table stored in the client computer.

FIG. 3 is an exemplary access table stored in the authentication computer server.

FIG. 4 is an exemplary message format used for communication between the client computer, authentication computer server, and the application computer server.

FIGS. 5A-5I are flowcharts illustrating a method for transmitting data through the computer network.

### DESCRIPTION OF AN EMBODIMENT

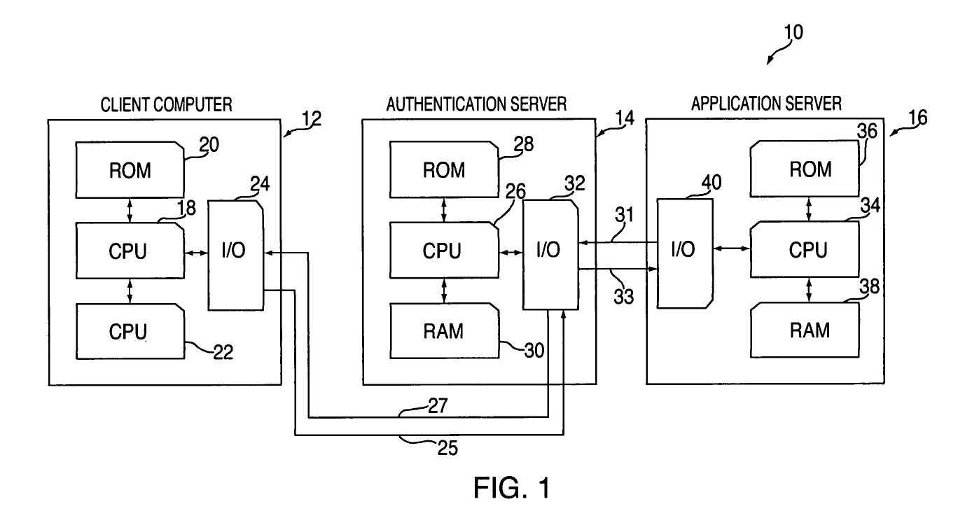

Referring to the drawings, identical reference numerals represent identical components in the various views. Referring to FIG. 1, networked system 10 includes a client computer 12, an authentication computer server 14, and an application computer server 16. A method for transmitting and authenticating messages in system 10 which decrypts data stored in a message only once during transmission of the message will be explained in greater detail below.

Client computer 12 is provided to transmit messages via authentication computer server 14 to application computer server 16. Each message may contain data that the application computer server 16 utilizes in software applications running in server 16. Authentication computer server 14 is provided to authenticate the identity of the client (also called sender herein) attempting to send a message to application computer server 10. If the identity of the client is authenticated, authentication computer server 14 transmits the message to application computer server 16.

Client computer server 12 includes a microprocessor 18 communicating with various computer readable storage medium. The computer readable storage media preferably includes nonvolatile and volatile storage in a read-only memory (ROM) 20 and a random access memory (RAM) 22. The computer readable medium may be implemented using any of a number of known memory devices such as PROMs, EPROMs, EEPROMS, flash memory or any other electric, magnetic, optical or combination memory device capable of storing data, some of which represent executable instructions used by microprocessor 18. Microprocessor 18 may communicate with authentication computer server 14 via an input/output (I/O) interface 24. In particular, microprocessor 18 may transmit messages through channel 25 (i.e., server 14 inbound channel) to server 14. Further, microprocessor 18 may receive messages from server 14 via channel 27 (i.e., server 14 outbound channel).

As illustrated, authentication computer server 14 includes a CPU 26, ROM 28, RAM 30 and I/O interface 32. I/O interface 32 is operably coupled to I/O interface 24 of client computer 12 and to I/O interface 40 of application computer server 16.

Application computer server 16 includes a CPU 34, ROM 36, RAM 38, and I/O interface 40. I/O interface 40 is operably coupled to 110 interface 32 of server 14.

Microprocessor 34 may transmit messages through channel 31 (i.e., server 16 outbound channel) to authentication computer server 14. Further, microprocessor 34 may receive messages from authentication server 14 via channel 33 (i.e., server 16 inbound channel).

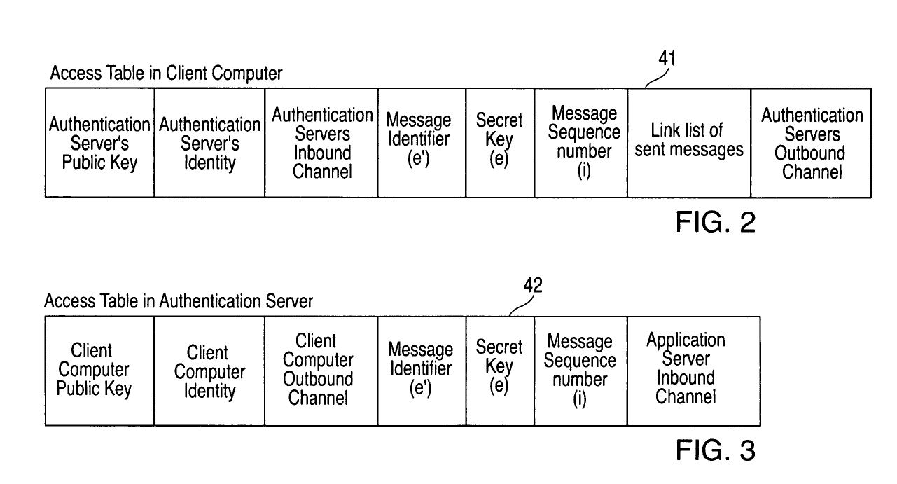

Referring to FIG. 2, an access table 41 used by client computer 12 for communicating with authentication computer server 14 is illustrated. The access table 41 may be stored in ROM 20 of computer 12. The access table 41 includes information that the client computer 12 utilizes to communicate with authentication server 14 in network 10 and for keeping track of the number and sequence of messages transmitted to authentication computer server 14. In particular, access table 41 includes the following information: (1) an authentication server public-key, (2) an authentication server identity, (3) an authentication server inbound channel, (4) an authentication server outbound channel, (5) a message identifier (e′), (6) a secret key (e), (7) a message sequence number (i), and (8) a link list of prior messages sent to server 14. The authentication server public-key corresponds to a key published by a Certificate Authority for server 14 which can be accessed by users of the Certificate Authority. The authentication server's identity corresponds to a code that identifies server 14. The authentication server inbound channel is a value corresponding to the communication channel 25 utilized by server 14 for receiving data from computer 12. The authentication server outbound channel is a value corresponding to the communication channel 27 utilized by server 14 for transmitting data to computer 12. The secret key (e) represents a random number generated in the authentication server 14 that is stored in both server 14 and computer 12. The message identifier (e′) represents a value obtained by encrypting the secret key (e) with a client public-key. The message sequence number (i) represents the sequence of a message sent from computer 12 to server 14 with respect to a plurality of sent messages. In other words when the message sequence number (i) equals the number “3”, or example, the message associated with that message sequence number is the third message sent in a group of related messages.

Referring to FIG. 3, an access table 42 used by authentication computer server 14 for communicating with client computer 12 is illustrated. The access table 42 may be stored in ROM 28 of server 14. The access table 42 includes information that the server 14 utilizes to communicate with computer 12 in network 10 and for keeping track of the number and sequence of transmit messages received from client computer 12. In particular, access table 42 includes the following information: (1) a client computer public-key, (2) a client computer identity, (3) a client computer outbound channel, (4) a message identifier (e′), (5) a secret key (e), (6) a message sequence number (i), and (7) application server inbound channel. The client computer public-key corresponds to a key published by a Certificate Authority for computer 12 which can be accessed by users of the Certificate Authority. The client computer identity corresponds to a code that identifies computer 12. The client computer outbound channel is a value corresponding to the communication channel 25 utilized by server 14 for receiving data from computer 12. The application server inbound channel is a value corresponding to communication channel 33 utilized by server 16 for receiving data from authentication server 14.

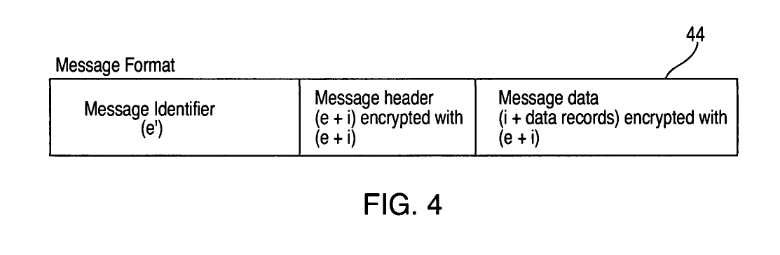

Referring to FIG. 4, a message format for messages sent from client computer 12 to authentication computer server 14 is illustrated. The message format may include: (1) a message identifier (e′), a message header, and message data. The message header may comprise the sum of (message sequence number (i)+secret key (e)) encrypted with the sum of (message sequence number (i)+secret key (e)). The message header will be utilized by authentication server 14 to authenticate the identity of client computer 12. The message data may comprise the message sequence number (i) and a plurality of data records that are encrypted with the sum of (message sequence number (i)+secret key (e)).

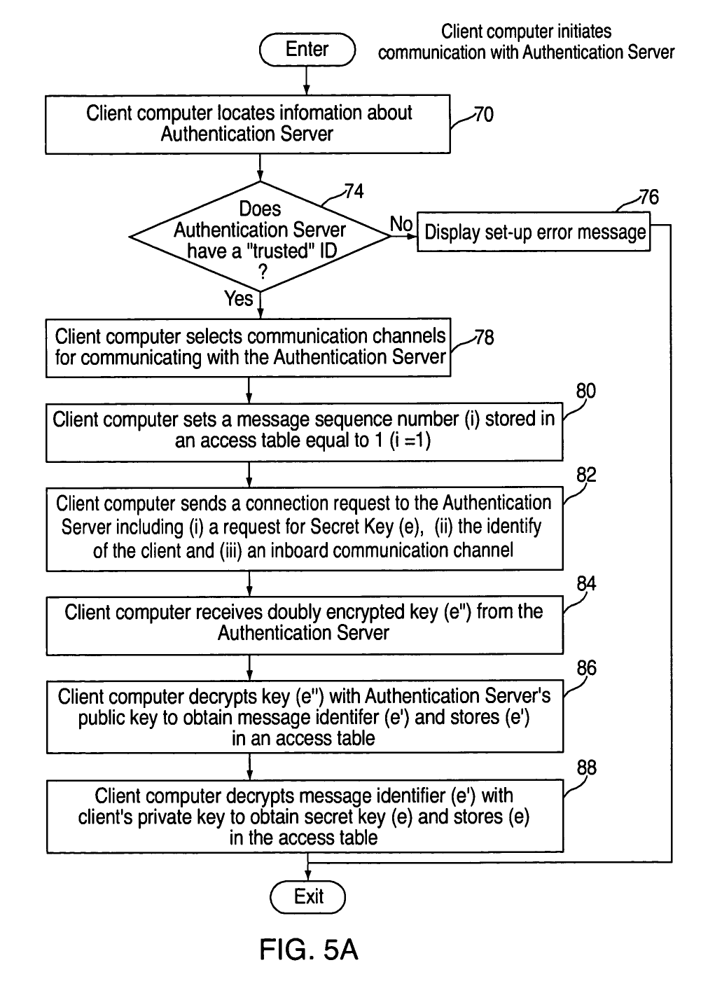

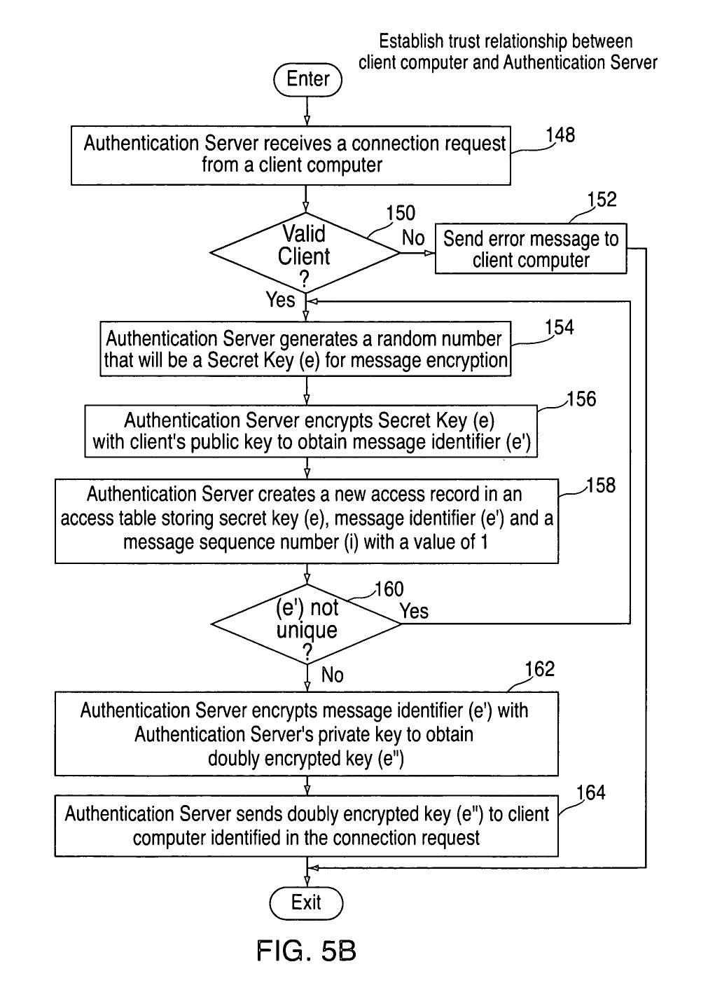

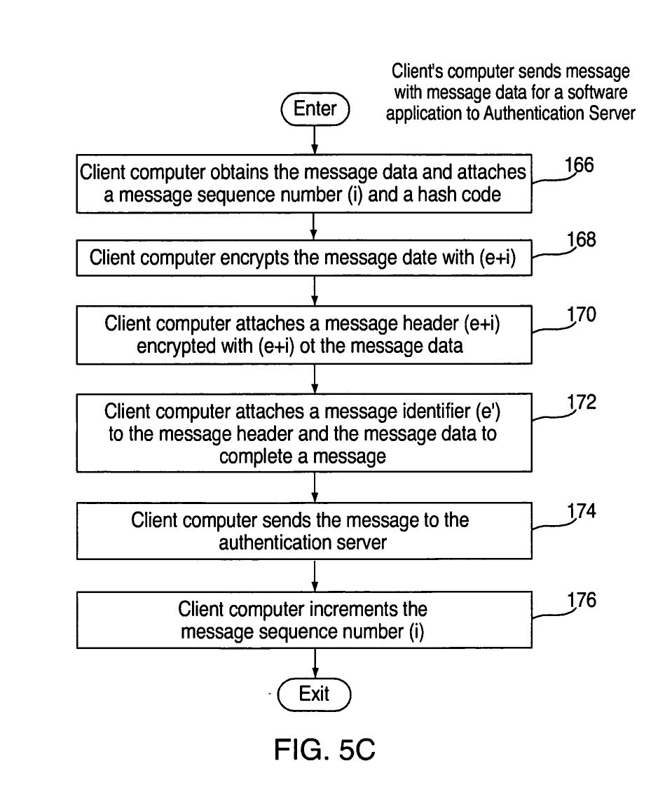

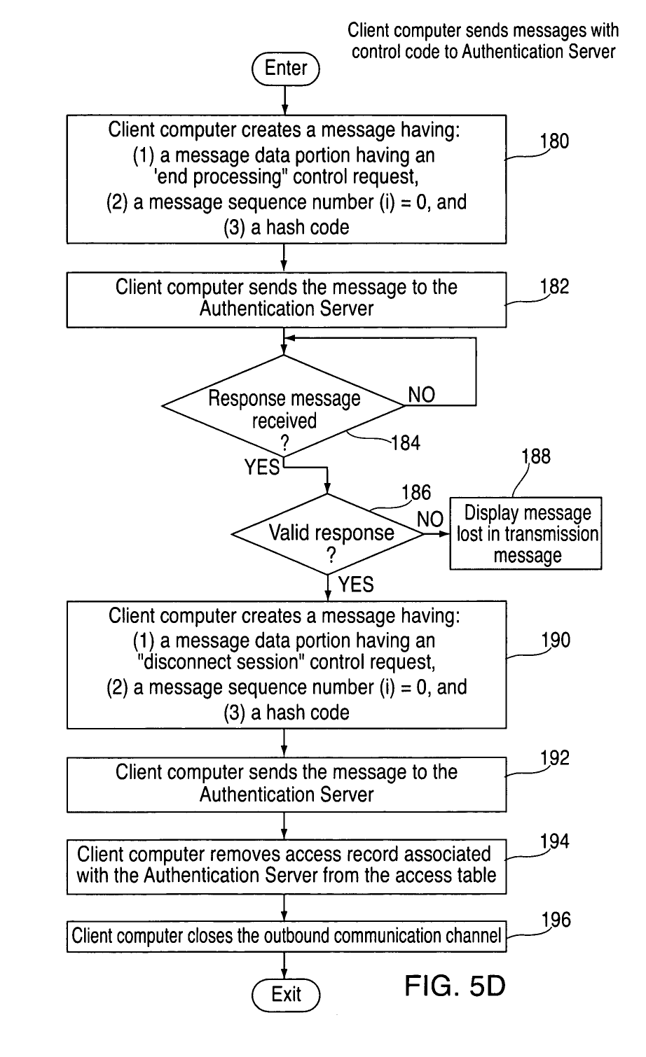

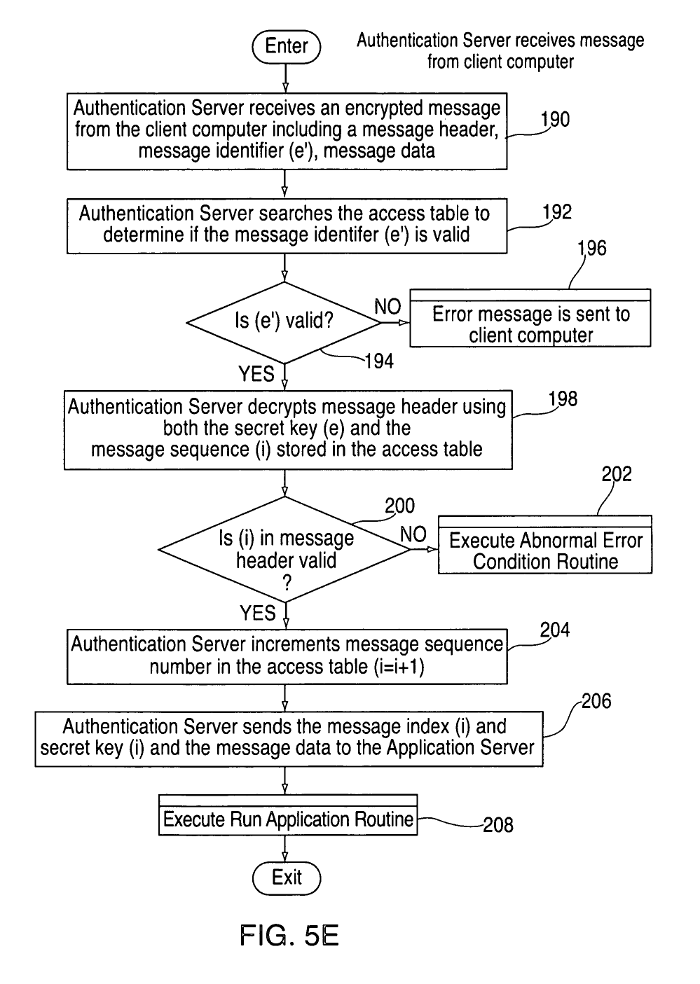

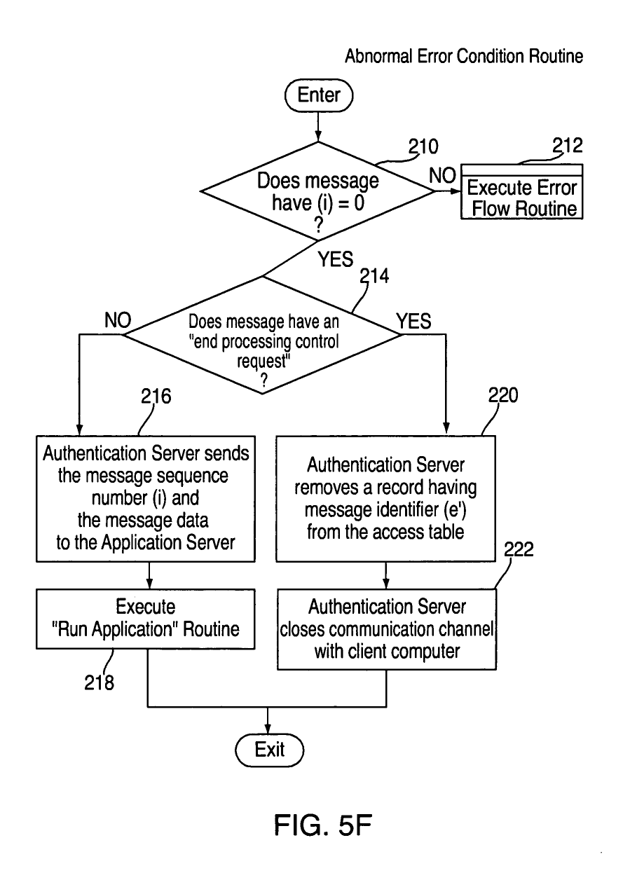

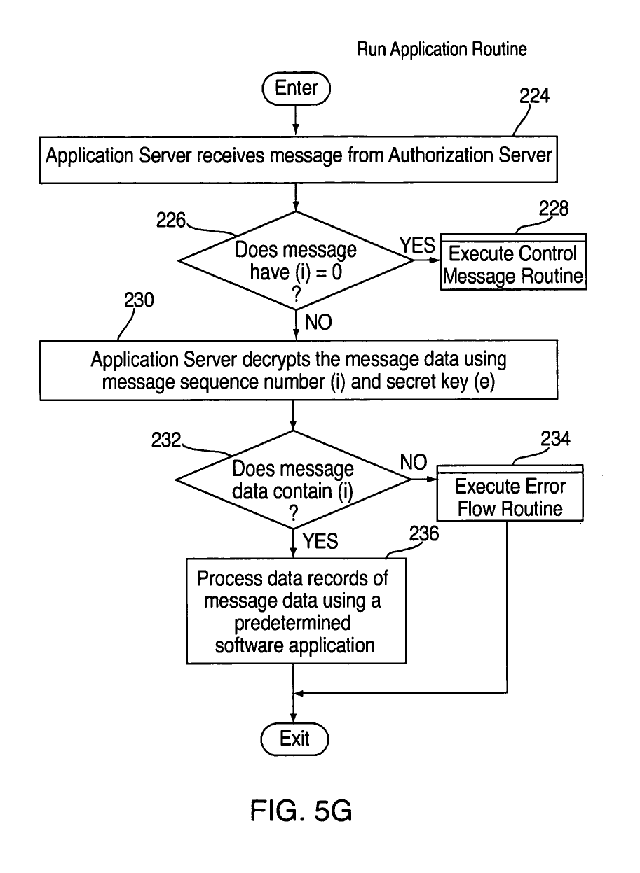

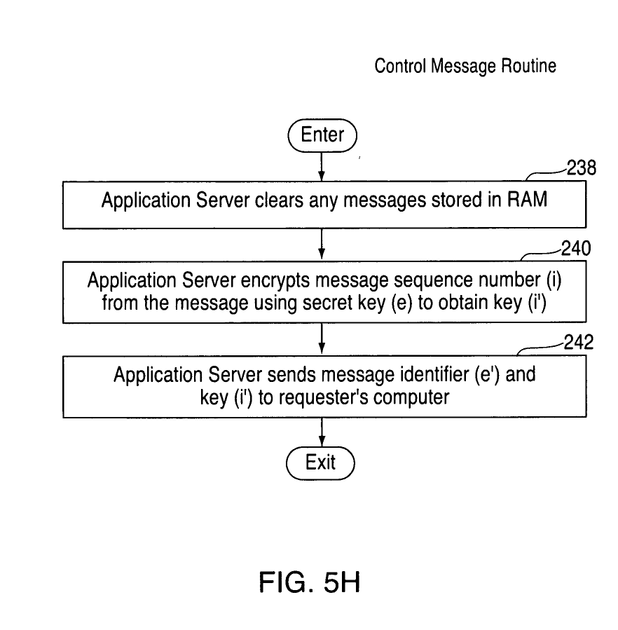

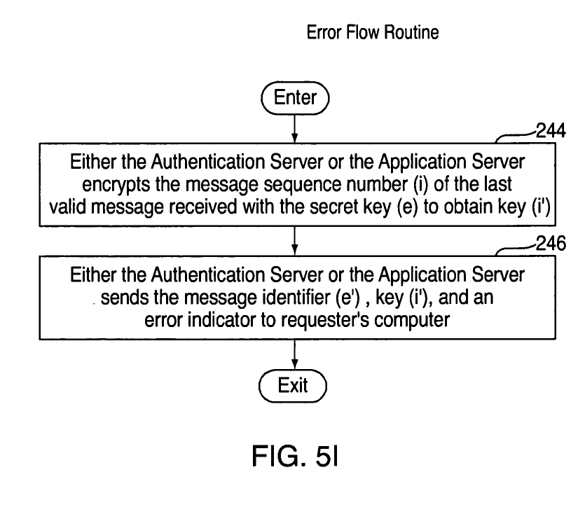

Referring to FIGS. 5A-5I, method for transmitting a message through computer network 10 and authenticating the message will now be explained. Further, the method provides for transmission of the message from client computer 12 through authentication computer server 14 to application computer server 16 while only decrypting message data associated with the message once at server 16.

Referring to FIG. 5A, a method for initiating communication between client computer 12 and authorization computer server 14 is provided. At step 70, client computer 12 locates information about authentication computer server 14. In particular, client computer can determine, for example, the public key of server 14 and the location of the Certificate Authority that is publishing the public key.

Next at step 74, client computer 12 makes a determination as to whether server 14 has a “trusted” ID. If the value of step 74 equals “yes”, the method executes steps 78-88. Otherwise, the method advances to step 76 which displays a “set up error” message on a computer monitor (not shown) connected to computer 12.

At step 78, client computer 12 selects a communication channel 25 for communicating with authentication server 78.

Next at step 80, client computer 12 sets a message sequence number (i) stored in access table 41 equal to “1” so that the next message sent will be considered the first sent message.

Next at step 82, client computer 12 sends a connection request to authentication computer server 14 including (i) a request for secret key (e), (ii) the identity of the client, and (iii) an inbound communication channel 27. Next at step 84, computer 12 receives a doubly encrypted key (e″) from authentication server 14.

Next at step 86, computer 12 decrypts key (e″) with authentication server's public-key to obtain message identifier (e′) and stores (e′) in access table 41.

Next at step 88, computer 12 decrypts message identifier (e′) with the client computer private key to obtain secret key (e) and stores (e) in access table 41.

Referring to FIG. 5B, a method for establishing a “trust” relationship between computer 12 and authentication computer server 14 will now be explained. At step 148, authentication computer server 14 receives a connection request from client computer 12. In particular, server 14 may receive the connection request via channel 25.

Next at step 150, authentication computer server 14 makes a determination as to whether the client is a “valid” client. In particular, server 14 may access a Certificate Authority to determine whether the connection request from computer 12 includes a public-key that is acceptable to server 12. If the value of step 150 equals “yes”, the method advances to step 154. Otherwise, the method advances to step 152 which sends an error message to client computer 12.

At step 154, authentication computer server 14 generates a random number in CPU 26 that will used as a secret key (e) for encrypting subsequent messages that will be transmitted between computer 12 and server 14.

Next at step 156, authentication computer server 14 encrypts secret key (e) with a public key associated with client computer 12 to obtain message identifier (e′).

Next at step 158, authentication computer server 14 creates a new access record in access table 42 to store the secret key (e), the message identifier (e′), and a message sequence number (i) having a value of “1”.

Next at step 160, authentication computer server 14 makes a determination as to whether message identifier (e′) is not unique in access table 42. If the value of step 160 equals “yes”, indicating that the message identifier (e′) is not unique, the method returns to step 154. Otherwise, the method advances to step 162.

At step 162, authentication computer server 14 encrypts message identifier (e′) with a private-key associated with authentication server can to obtain a doubly encrypted key (e″).

Next at step 164, server 14 sends the doubly encrypted key (e″) to client computer 12 identified in the received connection request.

Referring to FIG. 5C, the steps associated with client computer 12 sending a message to authentication server 14 with message data for a software application residing on application computer server 16. At step 166, client computer 12 obtains message data from ROM 20 or RAM 22 and attaches a message sequence number (i) and a “hash” code (also known as a Message Digest) to the message data.

At step 168, client computer 12 encrypts the message data with (e+i).

At step 170, client computer 12 attaches a message header (e+i) encrypted with (e+i) to the message data.

At step 172, client computer 12 attaches a message identifier (e′) to the message header and the message data to complete a message, as shown in FIG. 4.

At step 174, client computer 12 sends the message to the authentication computer server 14.

At step 176, client computer 12 increments the message sequence number (i) stored in access table 41.

Referring to FIG. 5D, the steps associated with client computer 12 sending messages with control codes to authentication computer server 14 is illustrated. In particular, the following steps will illustrate use of: (1) an “end processing” control request to notify server 16 that all of the associated messages have been transmitted, and (2) a “disconnect session” control request to notify server 16 that the session will be ended.

At step 180, client computer 12 creates a message having: (1) a message data portion having an “end processing” request, (2) a message sequence number (i)=0, and (3) a “hash” code.

At step 182, client computer 12 sends the message to authentication computer server 14.

At step 184, client computer 12 determines whether a response message was received from authentication computer server 14. If the value of step 184 equals “no”, the step 184 is repeated. In other words, computer 12 will wait until a response message is received from server 14. Otherwise, if the value of step 184 equals yes, the method advances to step 186.

At step 186, computer 12 makes a determination as to whether a received response is a valid response. If the value of step 186 equals “no”, a step 188 displays a message “messages lost in transmission” on a computer monitor (not shown) coupled to computer 12. Otherwise, the method advances to step 190.

At step 190, client computer 12 creates a message having: (1) a message data portion including a “disconnect session” control request, (2) a message sequence number (i)=0, and (3) a “hash” code.

At step 192, client computer 12 sends the message to authentication server 14.

At step 194, client computer 12 removes in access record associated with authentication computer server 14 from access table 41.

Next at step 196, client computer 12 closes outbound communication channel 25.

Referring to FIG. 5E, a method for receiving a message from client computer 12 by authentication server 14 will now be explained. At step 190, authentication computer server 14 receives an encrypted message from computer 12 that includes a message header, a message identifier (e′), and message data.

Next at step 192, authentication computer server 14 searches the access table 42 to determine if message identifier (e′) is a valid message identifier. If the value of step 194 equals “no”, indicating that message identifier (e″) is not valid message identifier, the method advances to step 196 which sends an error message from server 14 to computer 12. Otherwise, if the value of step 194 equals “yes”, the method advances to step 198.

At step 198, authentication computer server 14 decrypts the message header of the received message using both the secret key (e) and the message sequence number (i) stored in access table 42.

Next at step 200, server 14 makes determination as to whether the message sequence number (i) in the received message is valid. In particular, server 14 can compare the sequence number (i) in the received message to the sequence number (i) stored in access table 42 of server 14. If the value of step 200 equals “no”, the method advances to step 202 which executes an “abnormal error condition” routine, which will be explained in greater detail below. Otherwise, if the value of step 200 equals “yes”, indicating that the message sequence number (i) associated with a message was valid, the message is authenticated and the method advances to step 204.

At step 204, authentication computer server 14 increments a message sequence number (i) stored in access table 42 so that the stored message sequence number (i) will correspond to next received message.

Next at step 206, authentication computer server 14 sends the message index (i), secret key (e), and the message data to application computer server 16.

Next at step 208, application computer server 10 executes a “run application” routine which will be explained in greater detail below.

Referring to FIG. 5F, the steps associated with the “abnormal error condition” routine will now be explained. Abnormal error condition routine is provided to prevent missing, repeated, or corrupted messages from being utilized by a software application on application computer server 16.

At step 210, authentication computer server 14 will make a determination as to whether the message has a message sequence number (i) equal to a zero value. It should be noted that the message sequence number (i) may have a zero value when the message data comprises a control request value. If the value of step 210 equals “no”, the method advances to step 212 which executes and error routine which will be described in greater detail below. Otherwise, the method advances to step 214.

At step 214, authentication computer server 14 determines whether the message contains an “end processing” control request. In other words, server 14 determines whether the message indicates that all of the associated data records (in associated messages) have been transmitted from computer 12 to server 14. If the value of step 214 equals “no”, the method performs steps 216, 218.

At step 216, authentication computer server 14 sends the message sequence number (i) and the message data to application computer server 10. Next at step 218, application computer server 10 executes a “run application” routine that will be explained in greater detail below.

Referring again to step 214, if the value of step 214 equals “yes”, indicating that all the data has been sent to server 14, the method perform steps 220, 222.

At step 220, authentication computer server 14 removes a record having message identifier (e′) from access table 42.

Next at step 222, authentication computer server closes the communication channel 27 with computer 12 and the routine is exited.

Referring to FIG. 5G, the steps associated with a “run application” routine will now be explained. At step 224, application computer server 16 receives a message from authentication computer server 14.

Next at step 226, application computer server 16 determines whether the message has a message sequence number (i) equal to a zero value. If the value of step 226 equals “yes”, the method advances to step 228 which executes a “control message” routine, which will be explained in greater detail below. Otherwise, the method advances to step 230.

At step 230, application computer server 16 decrypts the message data using message sequence number (i) and secret key (e). As discussed above, application computer server 16 should acquire both (e) and (i) values to process the body of the message. If application computer 16 is the same machine as authentication server 14, it is anticipated that the information e.g. ((e) and (i)) would be shared. Alternately, when authentication computer server 14 and application computer server 16 are separate machines, then both (i) and (e) would be passed in the message body sent from authentication computer server 14 to application computer server 16. For stronger security, the preferred implementation would at least abstract (e) in a secure manner, away from the application. A service for decryption and validation would also be utilized. Similar functions dealing with security are already provided with products, such as IBM's Tivoli Access Manager. This product provides an Extended Privilege Attribute Certificate (EPAC) that deals with a session and would be used by application computer server 16 when requesting the decryption system services. The EPAC is an abstraction of (e), which would be retained with the EPAC in the Access Manager. This service would require the EPAC (created by authentication computer server 16), (i) and the encrypted body of the message as input. The service would return the decrypted message body, after validating that it related to the matching (i). If there is an inconsistency with the message body and the message sequence number (i), an error would be returned by the system service. One skilled in the art will recognize that this system service could be based on Triple Data Encryption Standard (DES) algorithm processing (as defined in ANSI X9.52).

At step 232, application computer server 16 determines whether the decrypted message data includes a valid message sequence number (i). If the value of step 232 equals “yes”, the method advances to step 236 which processes data records in the message data using a predetermined software application. Otherwise, if the value of step 232 equals “no”, the method advances to step 234 which executes an “error flow” routine which will be described in greater detail below.

Referring to FIG. 5H, the steps associated with a “control message” routine will now be explained. The control message routine is provided for synchronization of messages, as well as to enable an orderly shutdown and completion of the exchange of messages.

At step 238, application computer server 16 clears any received message is stored in RAM 38.

Next at step 240, application computer server 16 decrypts message sequence number (i) from the received message using secret key (e) to obtain key (i′).

Next at step 242, application computer server 16 sends message identifier (e′) and key (i′) to computer 12 via server 14. The message identifier (e′) and key (i′) are sent to computer 12 to inform computer 12 that all of the messages transmitted by computer 12 have been processed by application computer server 16.

Referring to FIG. 51, the steps associated with an “error flow” routine will now be explained. The error flow routine is provided for notifying the client computer 12 of dropped messages or repeated messages. When the client computer 12 receives the last message sequence number (i) successfully processed by application computer server 16, computer 12 can initiate an orderly recovery of the messages as known by those skilled in the art.

At step 244, either authentication computer server 14 or application computer server 16 encrypts the message sequence number (i) of the last valid message received with the secret key (e) to obtain key (i′).

Next at step 246, either authentication computer server 14 or application computer server 16 sends a message identifier (e′), key (i′), and error indicator value to computer 12 via server 14.

As discussed above, the computer network and method for transmitting data through the computer network provide substantial advantages over known systems. In particular, the method allows for the transmission and authentication of a message from a client computer through an authentication computer server to an application computer server while only decrypting the message data associated with the message once at the application computer server. Thus, the inventive method only decrypts the message data once during the transmission of the message instead of multiple times as done by known systems. Accordingly, the inventive method reduces the amount of computer processing effort that is utilized during transmission messages having relatively large amounts of data in a computer network.

While the invention is described with reference to an exemplary embodiment, it will be understood by those skilled in the art that various changes may be made an equivalence may be substituted for elements thereof without departing from the scope of the invention. In addition, many modifications may be made to the teachings of the invention to adapt to a particular situation without departing from the scope thereof. Therefore, is intended that the invention not be limited the embodiment disclosed for carrying out this invention, but that the invention includes all embodiments falling with the scope of the intended claims. Moreover, the use of the term's first, second, etc. does not denote any order of importance, but rather the term's first, second, etc. are us are used to distinguish one element from another.

1. A method for transmitting data through a computer network, the computer network including a first computer and a second computer both having a message sequence number stored therein, the method comprising:
transmitting a message containing a message identifier, an encrypted message sequence number, and encrypted data from the first computer to the second computer;
decrypting the encrypted message sequence number to authenticate the identity of the sending party who transmitted the message; and,
when the identity of the sending party is authenticated, the second computer initiating transmission of the message sequence number and the encrypted data to a third computer.

2. The method of claim 1 wherein the message sequence number is incremented in both the first computer and the second computer for each subsequent message transmitted from the first computer to the second computer.

3. The method of claim 1 wherein the message sequence number is initialized as a randomly generated number in one of the first and second computers.

4. The method of claim 1 further comprising the step of decrypting the first encrypted data in the third computer using the message sequence number.

5. A computer network, comprising:
a first computer operably communicating with a second computer, both the first and second computers having a predetermined message sequence number stored therein;
a third computer operably communicating with the second computer;
the first computer configured to transmit a message containing a message identifier, an encrypted message sequence number, and encrypted data to the second computer, the second computer configured to decrypt the encrypted message sequence number to authenticate the identity of the sending party who transmitted the message, the second computer further configured to transmit the sequence number and the encrypted data to the third computer after the identity of the sending party is authenticated by the second computer.

6. The computer network of claim 5 wherein the message sequence number is incremented in both the first computer and the second computer for each subsequent message transmitted from the first computer to the second computer.

7. The computer network of claim 5 wherein the message sequence number is initialized as a randomly generated number in one of the first and second computers.

8. The computer network of claim 5 wherein the third computer is further configured to decrypt the encrypted data using the message sequence number.
